(19) United States
(12) Patent Application Publication
(10) Pub. No.: US 2008/0202702 A1
(43) Pub. Date: Aug. 28, 2008

(54) Slat angle adjusting device for a venetian blind

(76) Inventor: Tai-Ping Liu, Lung-Ching Hsiang (TW)

Correspondence Address: COOPER & DUNHAM, LLP, 1185 AVENUE OF THE AMERICAS, NEW YORK, NY, 10036, US

(21) Appl. No.: 11/712,158

(22) Filed: Feb. 28, 2007

(51) Int. Cl. E06B 9/322

(52) U.S. Cl. 160/167 R

(57) ABSTRACT

A slat angle adjusting device for a venetian blind has a body, a drive device and an outer casing. The body is hollow and has a shell and a cover. The shell and the cover each have a mounting hole and a mounting recess. The drive device is rotatably mounted on the body and has a pinion, a rotating rod and a roller. The pinion is rotatably mounted in the mounting holes in the shell and the cover. The rotating rod is rotatably mounted in the mounting recesses of the shell and the cover and is engaged with the pinion. The roller is attached to the rotating rod and has a cord recess, a gap and a locking hole. The outer casing is detachably connected to the body and has a base and a protecting hood.

### BACKGROUND OF THE INVENTION

1. Field of the Invention

The present invention relates to a slat angle adjusting device, and more particularly relates to a slat angle adjusting device for a venetian blind.

2. Description of Related Art

With reference to FIG. 6, a conventional slat angle adjusting device (50) for a venetian blind in accordance with the prior art comprises a body (51), a base (52), a pinion (53), a drive axle, a rotating rod (54) and a roller (55). The body (51) has an interior, a bottom and a rear end. The base (52) is pivotally attached to the rear end of the body (51) below the bottom. The pinion (53) is rotatably mounted in the interior of the body (51). The drive axle is rotatably mounted in the interior of the body (51) and is engaged with the pinion (53). The rotating rod (54) is rotatably attached to the body (51) and has an inner end extending into the interior of the body (51) to engage with the drive axle. The roller (55) is attached to the rotating rod (54) over the base (52), and a tilt cord (40) is mounted around the roller (55) to rotate the roller (55) when the cord is pulled. When the tilt cord (40) is pulled, a tilt rod is rotated with the pinion (53) with the transmission of the roller (55), the rotating rod (54), the drive axle and the pinion (53). With the rotation of the tilt rod, the angle of slats of a venetian blind is adjusted.

However, the conventional slat angle adjusting device (50) for a venetian blind has the following shortcomings.

1. The tilt cord (40) is only reeled around the roller (55), and the tilt cord (40) may slip off the roller (55) when user pulls the tile cord (40). Thus, to rereel the tilt cord (40) onto the roller (55) of the conventional slat angle adjusting device (50) with the venetian blind is necessary but inconvenient.

2. The roller (55) is attached to the rotating rod (54) over the base (52), and no shelter is mounted over the roller (55). Thus, the tilt cord (40) may slip off the roller (55) from the top of the roller (55) and dust or impurities may dirty the tile cord (40).

3. With the base (52) being pivotally attached to the rear end of the body (51) below the bottom, to mount the conventional slat angle adjusting device (50) on the venetian blind will be blocked by the pivotable base (52).

To overcome the shortcomings, the present invention provides a slat angle adjusting device for a venetian blind to mitigate or obviate the aforementioned problems.

### SUMMARY OF THE INVENTION

The main objective of the present invention is to provide a slat angle adjusting device for a venetian blind that can be used and assembled to the venetian blind conveniently.

The slat angle adjusting device for a venetian blind has a body, a drive device and an outer casing. The body is hollow and comprises a shell and a cover. The shell and the cover each have a mounting hole and a mounting recess. The drive device is rotatably mounted on the body and has a pinion, a rotating rod and a roller. The pinion is rotatably mounted in the mounting holes of the shell and the cover in the body. The rotating rod is rotatably mounted in the mounting recesses of the shell and the cover and is engaged with the pinion. The roller is attached to the rotating rod and has a cord recess, a gap and a locking hole. The outer casing is detachably connected to the body and has a base and a protecting hood.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a slat angle adjusting device for a venetian blind in accordance with the present invention;

FIG. 2 is an exploded perspective view of the slat angle adjusting device for a venetian blind in FIG. 1;

FIG. 3 is a side view in partial sectional of the slat angle adjusting device for a venetian blind in FIG. 1;

FIG. 4 is a perspective view of a second embodiment of a slat angle adjusting device for a venetian blind in accordance with the present invention;

FIG. 5 is a perspective view of a third embodiment of a slat angle adjusting device for a venetian blind in accordance with the present invention; and

FIG. 6 is a perspective view of a conventional slat angle adjusting device for a venetian blind in accordance with the prior art.

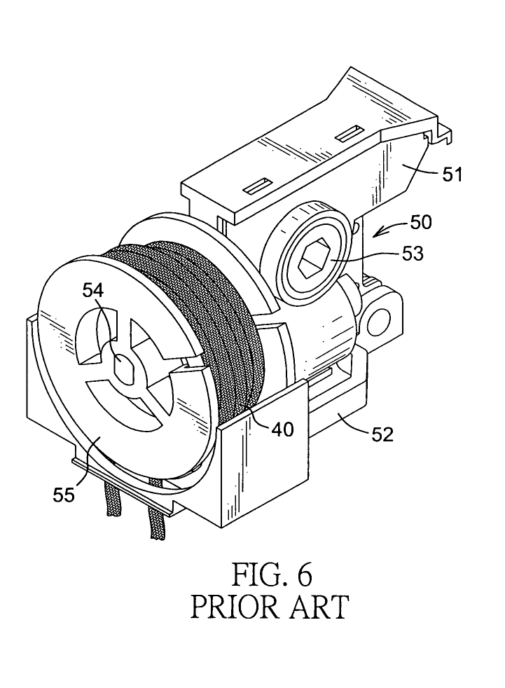

### DETAILED DESCRIPTION OF THE PREFERRED EMBODIMENT

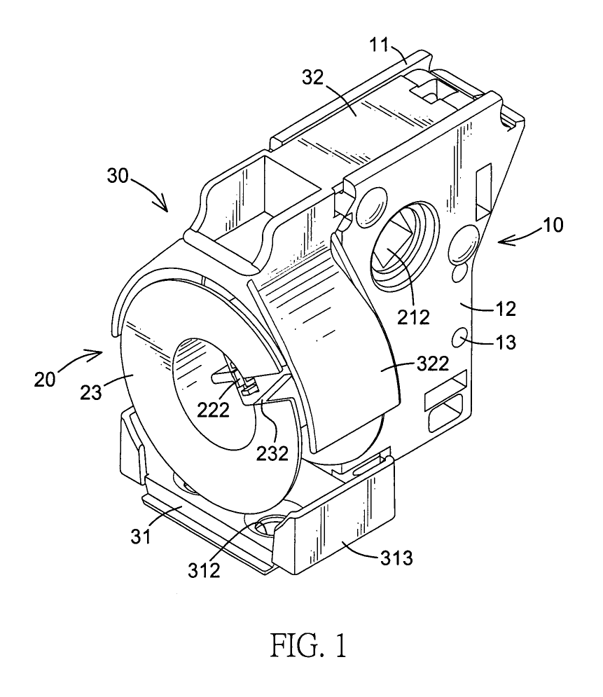

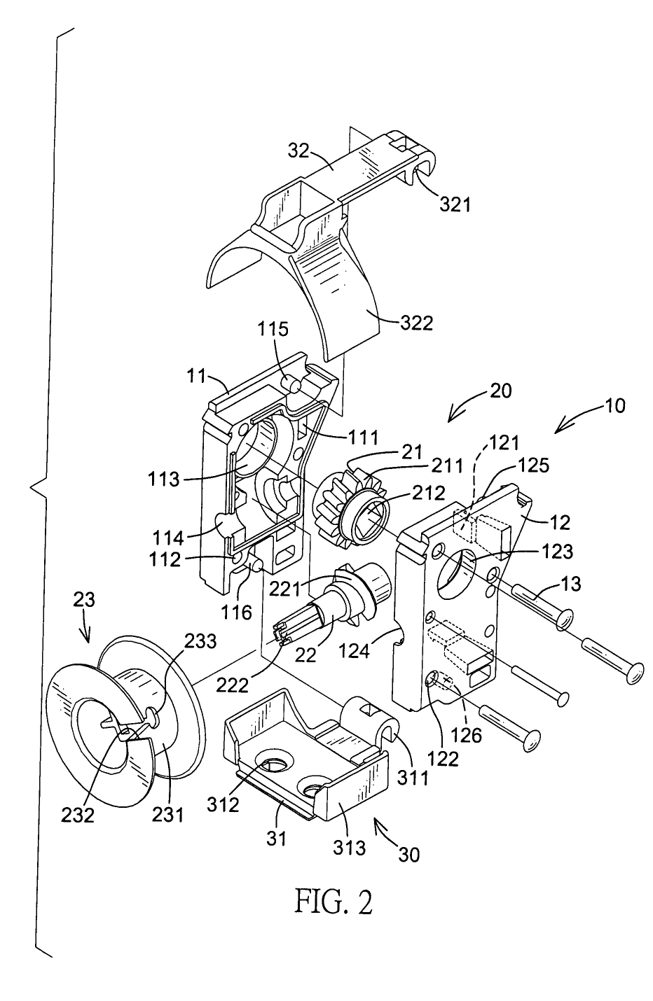

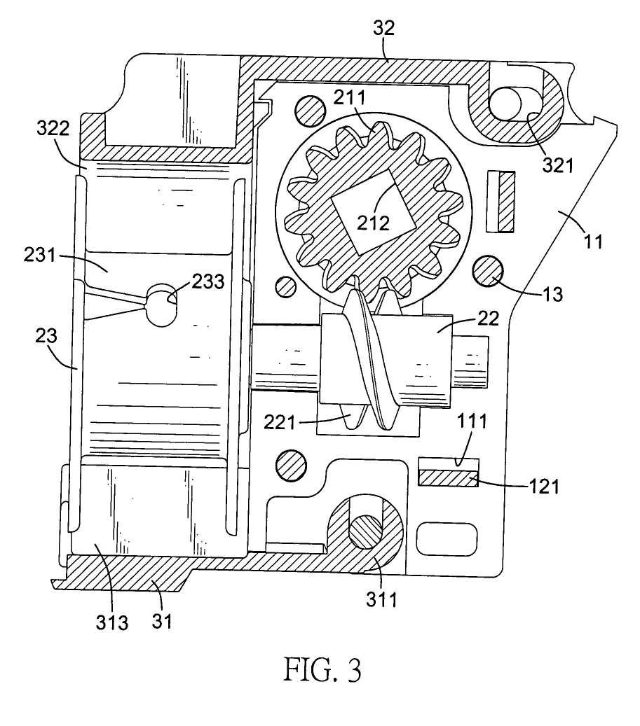

With reference to FIGS. 1 to 3, a slat angle adjusting device for a venetian blind in accordance with the present invention comprises a body (10), a drive device (20) and an outer casing (30).

The body (10) is hollow and comprises a shell (11), a cover (12) and multiple optional fasteners (13). The shell (11) has a top, a bottom, a front side, a rear side, an internal surface, multiple engaging holes (111), multiple through holes (112), a mounting hole (113), a mounting recess (114), a first pivot post (115) and a second pivot post (116). The engaging holes (111) are formed in the internal surface of the shell (11) near the rear side. The through holes (112) are formed through the shell (11) between the top, the bottom, the front side and the rear side. The mounting hole (113) may be circular and is formed through the shell (11) near the top between the front side and the rear side. The mounting recess (114) is formed in the internal surface of the shell (11) from the front side to the rear side below the mounting hole (113). The first post (115) is formed on the internal surface of the shell (11) over the mounting hole (113) near the rear side. The second pivot post (116) is formed on the internal surface of the shell (11) below the mounting recess (114) near the front side.

The cover (12) is symmetrized to the shell (11), is attached to the shell (11) and has a top, a bottom, a front side, a rear side, an internal surface, multiple engaging pins (121), multiple through holes (122), a mounting hole (123), a mounting recess (124), a first pivot post (125) and a second pivot post (126). The engaging hooks (121) are formed on the internal surface of the cover (12) near the rear side and are inserted in and hooked with the engaging holes (111) of the shell (11). The through holes (122) are formed through the cover (12) between the top, the bottom, the front side and the rear side and align respectively with the through holes (112) in the shell (11). The mounting hole (123) is formed through the cover (11) near the top between the front side and the rear side and is aligned with the mounting hole (113) in the shell (11). The mounting recess (124) is formed in the internal surface of the cover (12) from the front side to the rear side below the mounting hole (123) and is aligned with the mounting recess (114) of the shell (11). The first post (125) is formed on the internal surface of the cover (12) over the mounting hole (123) near the rear side and is aligned with the first pivot post (115) on the shell (11). The second pivot post (126) is formed on the internal surface of the cover (12) below the mounting recess (124) near the front side and is aligned with the second pivot post (116) of the shell (11). The fasteners (13) are extended through the through holes (112, 122) to combine the shell (11) with the cover (12).

The drive device (20) is rotatably attached to the body (10) and has a pinion (21), a rotating rod (22) and a roller (23). The pinion (21) is rotatably mounted in the mounting holes (113, 123) in the shell (11) and the cover (12) of the body (10) and has a center, an outer surface, a non-circular hole (212) and multiple oblique teeth (211). The non-circular hole (212) is formed through the center of the pinion (21), is engaged with a tilt rod with a non-circular cross section to drive the tilt rod to rotate with the pinion (21). The oblique teeth (211) are formed around the outer surface of the pinion (21).

The rotating rod (22) is rotatably mounted in the mounting recesses (114, 124) of the shell (11) and the cover (12), is engaged with the pinion (21) and has an inner end, an attaching end (222) and a helical tooth (221). The inner end is extended into the mounting recesses (114, 124) in the shell (11) and the cover (12). The attaching end (222) of the rotating rod (22) is extended out the front sides of the shell (11) and the cover (12) from the mounting recesses (114, 124). The helical tooth (221) is formed around the rotating rod (22) near the inner end and is engaged with the oblique teeth (212) of the pinion (21). The roller (23) is attached to the attaching end (222) of the rotating rod (22) and has a center, a connecting hole, two sidewalls, a cord recess (231), a gap (232) and a locking hole (233). The connecting hole is formed through the center of the roller (23), is mounted around the attaching end (222) of the rotating rod (22). The cord recess (231) is defined between the sidewalls of the roller (23) and has a bottom, and a tilt cord is mounted around the cord recess (231) of the roller (23). The gap (232) is formed through one of the sidewalls and is communicated with the cord recess (231) of the roller (23). The locking hole (233) is radially formed in the bottom of the cord recess (231) and is communicated with the gap (232). Accordingly, the tilt cord can mount around the roller (23) with engaging one end of the tilt cord with the locking hole (233) via the gap (232).

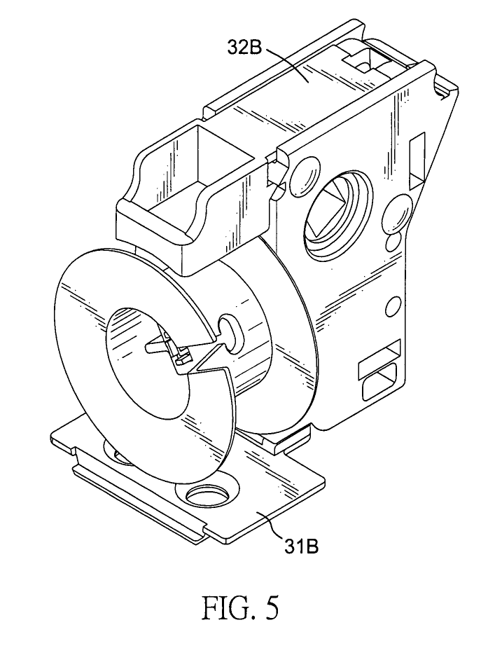

With reference to FIGS. 1, 2, 4 and 5, the outer casing (30) is detachable connected to the body (10) and has a base (31, 31A, 31B) and a protecting hood (32, 32A, 32B). The base (31, 31A, 31B) is connected to the shell (11) and the cover (12), has a rear edge, a bottom, two sidewalls, a connecting hook (311), two cord holes (312) and two flanges (313, 313A) and may have two extending plates (314A). The connecting hook (311) is formed on the rear edge of the base (31, 31A, 31B) and is hooked with the second pivot posts (116, 126) on the shell (11) and the cover (12). The cord holes (312) are formed through the bottom of the base (31, 31A, 31B), and the tilt cord is extended through the cord holes (312). The flanges (313, 313A) are respectively formed on the sidewalls of the base (31, 31A) from the bottom to hold the tilt cord between the flanges (313, 313A) and the cord recess (231) of the roller (23). The extending plates (314A) are respectively formed on and extend from the flanges (313A). With reference to FIG. 5, the flanges (313, 313A) and the extending plates (314A) can be omitted.

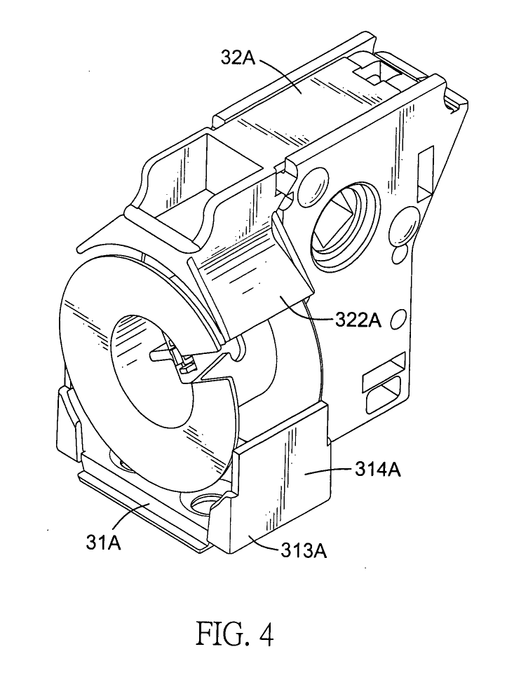

The protecting hood (32, 32A, 32B) is connected pivotally to the body (10) over the base (31, 31A, 31B) and has a rear end, a front end, two side edges, a pivot hook (321) and two protecting wings (322, 322A). The pivot hook (321) is formed on the rear end of the protecting hood (32, 32A, 32B) and engages with the first pivot posts (115, 125) on the shell (11) and the cover (12). The front end of the protecting hood (32, 32A, 32B) is extended over the roller (23). With reference to FIGS. 1 and 4, the protecting wings (322, 322A) are respectively formed on side edges of the protecting hood (32, 32A) on the front end to hold the tilt cord between the roller (23) and the protecting wings (322, 322A). The length of the protecting wings (322A) in FIG. 4 is shorter than the length of the protecting wings (322) in FIG. 1. With reference to FIG. 5, the protecting hood (32B) is formed without the protecting wings (322, 322A).

The slat angle adjusting device for a venetian blind as described has the following advantages.

1. With the arrangement of the locking hole (233) in the roller (23), the tilt cord can mount securely around the roller (23) with engaging one end of the tilt cord with the locking hole (233) from the gap (232).

2. The tilt cord is held around the roller (23) between the base (31, 31A, 31B) and the base (32, 32A, 32B), so the tilt cord can be prevented from slipping off the roller (23) when user pulls the tile cord and the dust or impurities will not dirty the tile cord.

3. Because the base (31, 31A, 31B) is pivotally and detachably attached near the front side of the body with the connecting hook (311) engaging with the second pivot posts (116, 126) on the shell (11) and the cover (12), to mount the slat angle adjusting device to the venetian blind will not be blocked by the base (31, 31A, 31B).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A slat angle adjusting device for a venetian blind having
a body being hollow and comprising
a shell having
a top;
a bottom;
a front side;
a rear side;
an internal surface;
a mounting hole being formed through the shell near the top between the front side and the rear side; and
a mounting recess being formed in the internal surface of the shell from the front side to the rear side below the mounting hole; and
a cover being symmetrized to the shell, being attached to the shell and having
a top;
a bottom;
a front side;
a rear side;
an internal surface;
a mounting hole being formed through the cover near the top between the front side and the rear side and being aligned with the mounting hole of the shell; and
a mounting recess being formed in the internal surface of the cover from the front side to the rear side below the mounting hole and being aligned with the mounting recess of the shell;
a drive device being rotatably mounted on the body and having
a pinion being rotatably mounted in the mounting holes in the shell and the cover of the body;
a rotating rod being rotatably mounted in the mounting recesses of the shell and the cover and being engaged with the pinion; and
a roller being attached to the attaching end of the rotating rod and having
a center;
a connecting hole being formed through the center of the roller and being mounted around the rotating rod;
two sidewalls;
a cord recess being defined between the sidewalls of the roller and having a bottom;
a gap being formed through one of the sidewalls and being communicated with the cord recess of the roller; and
a locking hole being radially formed in the bottom of the cord recess and being communicated with the gap; and
an outer casing being detachably connected to the body and having
a base being connected to the shell and the cover and having
a bottom; and
two cord holes being formed through the bottom of the base; and
a protecting hood being connected pivotally to the body over the base.

2. The slat angle adjusting device for a venetian blind as claimed in claim 1, wherein
the shell has
a first pivot post being formed on the internal surface of the shell over the mounting hole near the rear side; and
a second pivot post being formed on the internal surface of the shell below the mounting recess near the front side;
the cover has
a first post being formed on the internal surface of the cover over the mounting hole near the rear side and being aligned the first pivot post of the shell; and
a second pivot post being formed on the internal surface of the cover below the mounting recess near the front side and being aligned with the second pivot post of the shell;
the base has
a rear edge;
a connecting hook being formed on the rear edge of the base and engaging with the second pivot posts on the shell and the cover; and
the protecting hood has
a front end being extended over the roller;
a rear end; and
a pivot hook being formed in the rear end of the protecting hood and engaging with the first pivot posts on the shell and the cover.

3. The slat angle adjusting device for a venetian blind as claimed in claim 1, wherein the base has
two sidewalls; and
two flanges being respectively formed on the sidewalls of the base from the bottom.

4. The slat angle adjusting device for a venetian blind as claimed in claim 1, wherein the protecting hood has
two side edges; and
two protecting wings being respectively formed on side edges of the protecting hood on the front end.

5. The slat angle adjusting device for a venetian blind as claimed in claim 1, wherein the base has
two side edges;
two protecting wings being respectively formed on side edges of the protecting hood on the front end; and
two extending plates being respectively formed on and extending from the flanges.

6. The slat angle adjusting device for a venetian blind as claimed in claim 1, wherein
the pinion has
a center;
an outer surface;
a non-circular hole being formed through the center of the pinion; and
multiple oblique teeth being formed around the outer surface of the pinion; and
the rotating rod has
an inner end being extended into the mounting recesses in the shell and the cover;
an attaching end being extended out the front sides of the shell and the cover from the mounting recesses; and
a helical tooth being formed around the rotating rod near the inner end and being engaged with the oblique teeth of the pinion.

7. The slat angle adjusting device for a venetian blind as claimed in claim 1, wherein
the shell has multiple engaging holes formed in the internal surface of the shell near the rear side; and
the cover has multiple engaging hooks being formed on the internal surface of the cover near the rear side and being engaging with the engaging holes of the shell.

8. The slat angle adjusting device for a venetian blind as claimed in claim 1, wherein
the shell has multiple through holes formed through the shell between the top, the bottom, the front side and the rear side;
the cover has multiple through holes formed through the cover between the top, the bottom, the front side and the rear side and being aligned respectively with the through holes of the shell; and
the body has multiple fasteners being extended through the through holes in the shell and the cover to combine the shell with the cover.

9. The slat angle adjusting device for a venetian blind as claimed in claim 2, wherein the base has
two sidewalls; and
two flanges being respectively formed on the sidewalls of the base from the bottom.

10. The slat angle adjusting device for a venetian blind as claimed in claim 9, wherein the protecting hood has
two side edges; and
two protecting wings being respectively formed on side edges of the protecting hood on the front end.

11. The slat angle adjusting device for a venetian blind as claimed in claim 10, wherein the base has two extending plates being respectively formed on and extending from the flanges.

12. The slat angle adjusting device for a venetian blind as claimed in claim 11, wherein
the pinion has
a center;
an outer surface;
a non-circular hole being formed through the center of the pinion; and
multiple oblique teeth being formed around the outer surface of the pinion; and
the rotating rod has
an inner end being extended into the mounting recesses of the shell and the cover;
an attaching end being extended out the front sides of the shell and the cover from the mounting recesses; and
a helical tooth being formed around the rotating rod near the inner end and being engaged with the oblique teeth of the pinion.

13. The slat angle adjusting device for a venetian blind as claimed in claim 12, wherein
the shell has multiple engaging holes formed in the internal surface of the shell near the rear side; and
the cover has multiple engaging hooks being formed in the internal surface of the cover near the rear side and being engaged with the engaging holes of the shell.

14. The slat angle adjusting device for a venetian blind as claimed in claim 13, wherein
the shell has multiple through holes formed through the shell between the top, the bottom, the front side and the rear side;
the cover has multiple through holes formed through the cover between the top, the bottom, the front side and the rear side and being aligned with the through holes of the shell; and
the body has multiple fasteners being extended through the through holes of the shell and the cover to combine the shell with the cover.
